(19) United States
(12) Patent Application Publication
(10) Pub. No.: US 2011/0055290 A1
(43) Pub. Date: Mar. 3, 2011

(54) PROVISIONING A GEOGRAPHICAL IMAGE FOR RETRIEVAL

(76) Inventors: Qing-Hu Li, Beijing (CN); Qiming Chen, Cupertino, CA (US)

(21) Appl. No.: 12/988,368

(22) PCT Filed: May 16, 2008
(86) PCT No.: PCT/CN2008/070982

§ 371 Date: Oct. 18, 2010

(51) Int. Cl. G06F 17/30

(52) U.S. Cl. 707/807; 707/E17.005

(57) ABSTRACT

A system for provisioning a geographical image for retrieval, comprising: an application server operating to receive a query for a geographical region in a geographical area of coverage; and a database server operating to store a plurality of geo-image tiles that cover the geographical area of coverage at different zoom levels, the database server is coupled to the application server to receive the query from the application server and return one or more of the plurality of geo-image tiles to illustrate the geographical region requested in the query; wherein the plurality of geo-image tiles are partitioned for storage in the database server in accordance with a database management system (DBMS) scheme and indexed or retrieval with a non-spatial index.

### BACKGROUND

Internet-based mapping, such as web-mapping, becomes popular with the introduction of Google™ Maps, Microsoft® Virtual Earth™ and Yahoo!® Maps because it provides visualization of the world as well as detailed geographic areas in terms of geographical images (hereinafter, “geo-images”), including raster maps, satellite images and Digital Elevation Models (DEMs). Thus, geo-images provide aerial and satellite views in a very simple and comfortable manner in a web-based environment. Conventionally, an image tiling scheme is employed to flexibly store and retrieve geo-images for Internet-based mapping. Under a tiling scheme, a geo-image is partitioned into multiple “tiles.” The tiles may be viewed as partial image data sets in a designated image format such as JPEG, and one or more image databases are used to store tiles of the geo-image instead of the whole image. When a particular portion of the geo-image covering a given geographical area is requested, such as a request for a map, corresponding tiles of the image are retrieved and composed. Then, the requested image portion is displayed by stitching together in a graphical user interface (GUI), such as a web browser, the set of pre-rendered tiles.

For images that have multiple levels of coverage and resolution such as satellite images, their corresponding subdivided tiles also have multiple levels. For example, to cover the entire continental United States, either a few small-scale tiles or hundreds of millions of large-scale tiles are used, with a total size of hundreds of Gigabytes stored on a tile server. Thus, when a web surfer selects a mapping of an area in the continental United States by performing drag and zoom operations on a geo-image thereof, one or more tile servers supply those tiles that have the appropriate resolution and cover the requested location window (e.g., a rectangle) representing visible boundaries. The geographical area covered by such a requested window is referred herein as a geographical bounding rectangle (GBR).

The tiling scheme is typically used for web-mapping applications because the GBR being browsed by a web surfer is only a very small portion of a whole geographical area of interest, and the size of the geo-image data covering the whole area is so large that it is not possible to store them in a client's disk or to download all of them in real time from the tiling server. Thus, the conventional approach is to subdivide the surface of the whole geographic area at each different zoom level into tiles with an appropriate smaller size and store them in one or more tile servers. Given a GBR and a viewing window rectangle (WR), the tile server will only respond with tiles both at fixed zoom level and occupied by the requested GBR.

To support a huge number of clients' image requests efficiently, existing solutions typically employ multiple tile servers operating or processing in parallel to implement a tiling scheme for image provisioning to service the many requests. For example, web mapping may be serviced by a distributed file system (DFS) having multiple file chunk servers therein for storing tiles. Typically, the DFS also includes a master server for directory service. There are several limitations in using a DFS to store images, such as geo-images, for web mapping services. First, each chunk server maintains a fixed partition of images and processes queries individually. As a result, they cannot be optimized for load balance if the requests for images in one geographical area are much higher than requests for images in another geographical area. Second, the DFS can only respond with an individual tile at a time because it does not have a mosaic functionality at the server side to provide a whole geo-image according to a GBR. Thus, most image customization is performed on the client side rather than on the server side. Consequently, there is a potential loss of server side information integration and service chaining, and thus a potential loss of benefits of a service oriented architecture (SOA).

In another example, web mapping may be serviced by the parallel processing in a SQL system having multiple SQL server databases therein. Each SQL server database is responsible for managing and retrieving images in a particular geographic zone, and these zones are geographically partitioned. A participating SQL server database in the SQL system has only a mosaic functionality over locally stored image tiles, and not a cropping functionality. Because these individual SQL server databases are not collaborative, the SQL system cannot provide images across zones. Therefore, it also fails to provide the whole geo-image with an arbitrary GBR. Further, the SQL system does not optimize load balance. Like the DFS mentioned above, each SQL server database maintains a fixed partition of images. Thus, the participating SQL server databases are not cooperative as data not shared, with the possibility of some servers overloading while others are idling.

In general, the aforementioned current solutions for Internet-based mapping commonly organize images by geographic zones, and store the tiles of each image in a single tile server. Consequently, (a) assembling images across zones is not supported by the tile servers; (b) when a query requests multiple images in the same geographic zone, the tiles of these images may not be retrieved in parallel as they are located in the same tile server; and (c) when the request rate for the images covering one geographical area is significantly higher than that covering another geographical area, the corresponding tile severs may not be load balanced. Thus, the existing solutions have limitations in supporting intra-query parallelism, that is, the capability of subdividing a query into multiple sub-queries to be executed in parallel. They also have limitations in supporting inter-query parallelism, that is, the capability of balancing servers' loads to answer multiple queries concurrently.

Accordingly, there is a desire to provide image provisioning, for example, via Internet-based mapping such as web mapping, that is characterized by server-side mosaic and cropping functionalities to provide information integration and service chaining to reap the benefits of a SOA. Furthermore, there is a desire to provide image provisioning that includes the capability to cover an arbitrary GBR hierarchically and supports both inter-query parallelism and intra-query parallelism.

### BRIEF DESCRIPTION OF THE DRAWINGS

Embodiments are illustrated by way of example and not limited in the following figure(s), in which like numerals indicate like elements, in which:

FIG. 1 illustrates a sequence of hierarchical subdivisions of a geographical area of coverage into image tiles, according to one embodiment.

FIG. 2 illustrates a naming convention for subdivided image tiles, according to one embodiment.

FIG. 3 illustrates a hash-range partitioning mechanism used to partition image tiles for storage, according one embodiment.

FIG. 4 illustrates a data flow chart responding to a query for a geo-image, according to one embodiment.

FIG. 5 illustrates a process or hierarchically subdividing a geographical n image request process, according to one embodiment.

FIG. 6 illustrates a geographic information service that may be integrated with a H-Tiling scheme, according to one embodiment.

FIG. 7 illustrates a process for hierarchically subdividing a geographical area of interest into image tiles, according to one embodiment.

FIG. 8 illustrates a process for receiving and responding to a query for a geo-image, according to one embodiment.

FIG. 9 illustrates a processing for integrating a geographic information service with a H-Tiling scheme, according to one embodiment.

FIG. 10 illustrates a computing platform that may be used to implement a H-tiling scheme, according to one embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

Described herein are systems and methods for hierarchically dividing a geo image into a number of tiles and indexing the tiles such that those overlapping an arbitrary GBR may be retrieved efficiently for image provisioning. In one embodiment, a geo-image is divided in a quad-tree manner, wherein each quad-tree node represents an image tile with an assigned identifying number (ID) that may be generated by encoding the geographical location information of the tile. Upon receiving an arbitrary GBR and a WR as requested by, for example, a web browser, a tile server operates to identify the IDs of those tiles that overlap the GBR after fixing a zoom level. If the overlapped tiles are stored in a database table, a database index (e.g., a b-tree index) may be created on the ID column to accelerate a subsequent query processing. In another embodiment, there is provided organization and indexing of image tiles at the server side based on parallel database technology. This provides more flexible, across-zone image compositions for various applications and support for inter-query parallelism and intra-query parallelism for high-throughput image provisioning. Tile indices are also co-partitioned with the indexed data for locality based optimization. Furthermore, the tilling scheme of images may be integrated with other location oriented information to support a wide spectrum of applications that use geo-images.

Accordingly, in one embodiment, a system based on parallel database, rather than a DFS or a system with multiple databases, is used to implement the tiling scheme and tile indexing therein. In such a system, tiles are hash-partitioned and range-partitioned for parallel query processing. B-tree indices are used in the system, and they are co-partitioned with data for locality based optimization. Furthermore, the multiple nodes of the parallel database system are load balanced to support both inter-query parallelism and intra-query parallelism. For example, when multiple tiles are requested, the sub-queries of a single “big” query may be parallelized for concurrent execution.

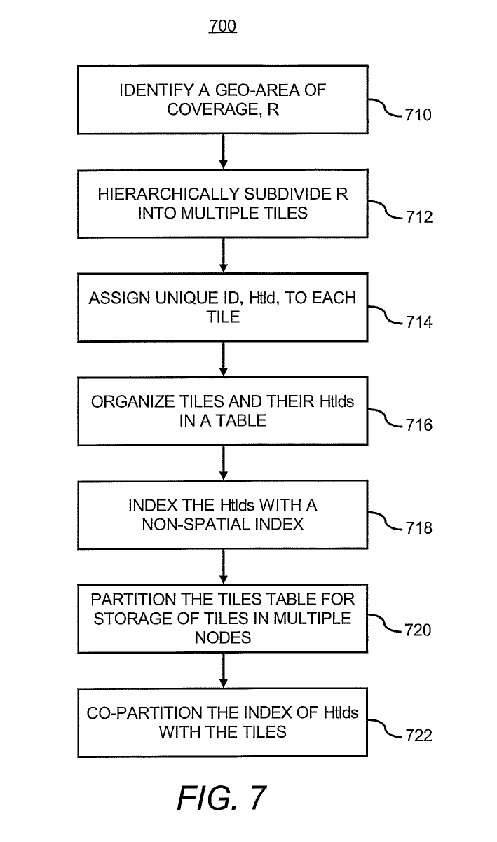

Proper server-side tile management includes proper indexing of tiles in order to efficiently retrieve, from the large number of stored tiles, those tiles that cover or overlap a visible bounding box such as a GBR. Spatial indexing is often used in existing solutions to retrieve location-related data, including geo-image tiles. The inventors have also noted that indexing is typically employed in a database management system (DMBS) for efficient query execution. Thus, in various embodiments for tile-based geo-image provisioning as described herein, a DBMS index (e.g., a B-tree index) is leveraged, rather than a specific spatial index that is conventionally used, to provide a more reliable and faster tile access. In one embodiment, a DBMS index is employed in a geo-image tile indexing scheme called a Hierarchical Tiling (H-Tiling) scheme that includes two parts: 1) a first process to hierarchically divide the surface captured in a geo-image into tiles; and 2) a second process to retrieve the tiles that intersect with the query window. The first process for hierarchically subdividing a geo-image of a geographical area of coverage into tiles is described below with reference to FIG. 7, with further supports from other figures as indicated.

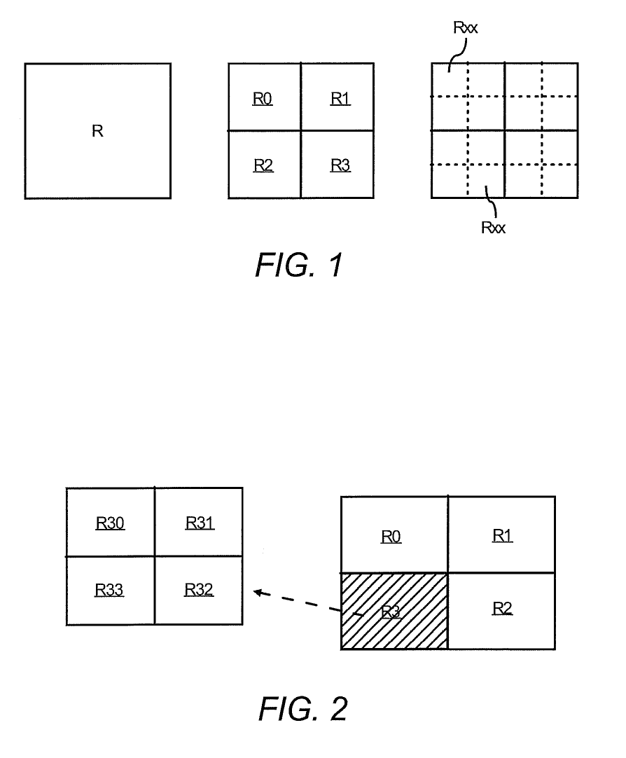

At 710, the hierarchical subdivisions of a geo-image starts with an identification of a desired geographical area of coverage, represented by a square (rectangle or any parallelogram) named R at level 0, as illustrated by FIG. 1. An example of a satellite image of the Earth is used herein as the desired geographical area of coverage to describe the H-Tiling scheme. Thus, the square R represents a two-dimensional projection of the satellite image or geo-image of the Earth. However, it should be understood that the square R may represent any physical area of interest, on Earth or otherwise.

At 712, The square R is hierarchically subdivided into multiple image tiles, with each tile having available image content from, for example, a satellite image. These hierarchical subdivisions involve a recursive decomposition of the original geo-image, or square R. FIG. 1 depicts the sequence of subdivisions, starting with the square 110 named R that represents the entire original geo-image at level 0. First, at level 1, the square 110 is subdivided into square tiles of equal size, e.g., 2²=4, 3²=9, 4²=16, etc. In one embodiment, the square 110 is subdivided in a quad-tree manner into four square tiles R0, R1, R2, and R3 so as to use only 2 bits to encode each level of subdivided tiles (as further explained below). Second, at level 2, each of the four tiles R0-R3 is subdivided again in a quad-tree manner so as to form 2²×2²=16 squares Rxx (where x represents a digit) from the original square R. Thus, as illustrated, to get the next level details recursively, a particular rectangle is divided by its two midlines. The number of subdivided levels depend on the number of levels of coverage and resolution available for the original geo-image. Thus, for example, if there are X number of available multiple levels of coverage and resolution of satellite images of the Earth, the square R is hierarchically subdivided into the same X number of multiple of levels of image tiles, or H-Tiling tiles. Because the square R represents the Earth surface, the hierarchical subdivisions are based on the Mercator projection, which transforms the longitude and latitude of a vertex of a rectangle into the Mercator coordinates. The following equations determine the x and y coordinates of a point on a Mercator map, in this case, the square R from its longitude λ and latitude φ:

$$x = λ , y = \frac{1}{2} ln ( \frac{1 + sin ( φ )}{1 - sin ( φ )} ) .$$

After subdividing the original square R (which is a parent square) into four smaller ones (which are child squares), the smaller squares are numbered clockwise from 0 to 3, and these square numbers are appended to the name of the original square R to get the name of each new square. Thus, as illustrated in FIG. 1, the four squares are named R0, R1, R2, and R3. Likewise, as illustrated in FIG. 2, after subdividing the rectangle R3 into four smaller ones that are numbered clockwise from 0 to 3, these smaller ones are named R30, R31, R32, and R33. This process is recursive or repetitive, and the naming scheme is to append the number of the child rectangle to its parent's name. As shown in FIG. 1, the root square is square R.

At 714, each of the H-Tiling tiles at all levels is given or assigned a unique integer identification (ID). The name of an H-Tiling tile, also referred herein as an H-Tiling node, may be encoded to an integer ID by assigning two bits to each level and encoding the original square R as 1. For example, R13 may be encoded as binary 10111; thus, a 64-bit integer may hold an H-Tiling ID up to level 31. The ID encoding is unique for each H-Tiling node. Thus, given an ID, Htld, of any H-Tiling node, the node's level may be obtained from following formula:

level(Htld)=floor(log 4(Htld)),

wherein, as understood in the art, floor(x) is a basic math function available in most computer programming languages that outputs the largest integer less than or equal to x.

The minimum and maximum longitudes and latitudes of each H-Tiling node may be determined from the aforementioned equations for (x,y) and (λ,φ). Conversely, given a geographical point, its level l may be determined, from which the ID, Htld, of the H-Tiling node may be calculated. This H-Tiling node is the only one at level l that contains the given point.

Instead of a conventional DFS or a system with multiple SQL server databases as described above, a parallel database system may be used to store the generated tiles. An example of such a system is a parallel DBMS. Thus, at 716, after the aforementioned hierarchical subdivision phase, which may be performed offline, all the tiles at different levels may be organized in a table like the one depicted in Table 1. As shown in the table, the “Htld” column indicates the integer ID of a tile. The “Content” column indicates the corresponding image content of each tile in a Binary Large Object (BLOB) data format (or any other desired data format). The corresponding image content of each tile is the available geo-image at the resolution corresponding to each tile at its particular level.

TABLE 1

| HtId | Content |
|---|---|
| 1 | [BLOB] |
| 10 | [BLOB] |
| 11 | [BLOB] |
| 12 | [BLOB] |
| 13 | [BLOB] |

At 718, a non-spatial index, such as a traditional DBMS index (B-Tree, Hash-index, etc.), is created on the “Htld” column so as to index the unique integer IDs of the tiles for querying.

The parallel database system, such as a parallel DBMS, includes multiple processors, herein referred to as processing nodes (as opposed to H-Tiling nodes discussed above). Thus, at 720, Table 1 is then partitioned for storing tiles in the multiple processing nodes. A table may be partitioned based on various partitioning schemes or methods for a database system (e.g., DBMS), such as a hash-partition, a range partition, a list partition, or a range-list partition.

Under a hash partitioning of a table, one attribute, a composite of multiple attributes, a certain function of one attribute, or a function of the composite of multiple attributes is selected as the partition key. For example, the partition key may be an attribute of the H-Tiling IDs, a function of the H-Tiling IDs, and/or one or more attributes of the image content in the tiles. The records of the table are then partitioned based on a designated hash function that is applied to the values of the selected partition key, where records having the same hash value of partition keys are distributed to the same node. Under a range partitioning of a table, records are distributed to multiple nodes based on the value ranges of a selected attribute or attributes.

In the aforementioned parallel database system, all processing nodes therein may process queries, no matter where the data is located, and a request distributor operates to balance the loads of these nodes. In contrast, with the conventional multi-database approach, a data partition is associated with a designated server node and thus accessible only by that node. Accordingly, the parallel database system as described herein is better able to support inter-query parallelism than the conventional multi-database approach. Also, under various partitionings of a table, the tiles making an image may be located in multiple nodes and therefore may be accessed in parallel. Thus, a parallel database approach as described herein further supports intra-query parallelism.

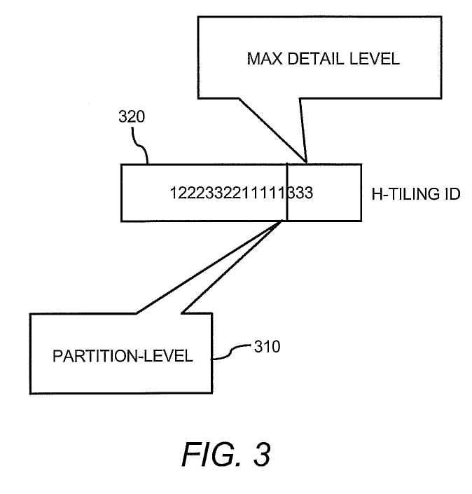

Because the image tiles in the H-Tilling scheme represent a hierarchy of geographic regions, it is desirable to hash partition these regions for parallel processing while limiting such a hash partition to a certain level of the hierarchy. Otherwise, hash partitioning beyond a certain detailed tile level may cause increased inter-node communication which, in turn, may override the benefits of parallel tile access. Accordingly, FIG. 3 illustrates a hash-range partitioning mechanism being employed, wherein, along with the H-Tilling hierarchy, a partition-level 310 is introduced, whereby the H-Tiling ID corresponding to this partition-level is the “prefix” 320 of the IDs of all its descendent tiles. In one embodiment, a function is defined to extract this “prefix” from those descendants. In this way, the hash partition of tiles on the partition key becomes a hash-range partition. That is, above the partition-level 310, tiles are hash partitioned (i.e. coarser tiles are hash partitioned), and then below the partition-level 310, tiles in the same geographic range are co-located (i.e., located in the same processing node).

Accordingly, the partition-level 310 provide the prefix length of the H-Tilling ID, on which the hash-partitioning function may be computed. There is a tradeoff in determining the partition-level 310 for a hash-partitioned index. The bigger the partition-level, the more H-tilling digits (i.e., more information) on which the hash function is required to calculate, which requires more processing resources. However, this contributes to a better balance between the partitions. Therefore, the partition-level 310 may be chosen or selected to be the minimum level that provides a desired balance between the hash partitions. It should be noted that the partition key is not a unique index to tiles. Rather, it determines which node a tile resides, and that tile may be retrieved using the index of the unique Htlds (e.g., the B-tree) for the tiles that is localized to that node.

Not only tiles but also the index of the unique Htlds of the tiles may be partitioned. Thus, at 722, the index of the unique Htlds is partitioned. In one embodiment, the table of tiles and the index of the unique Htlds may be co-partitioned, i.e., the index partition and the tiles it indexes are co-located in the same node. Because the index entries are H-Tiling IDs, they may be co-partitioned with the tiles based on the same partition key values (e.g., for the hash-range partition).

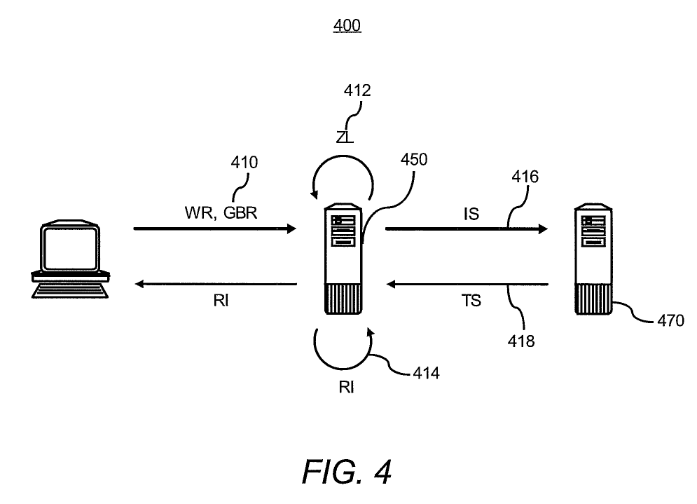

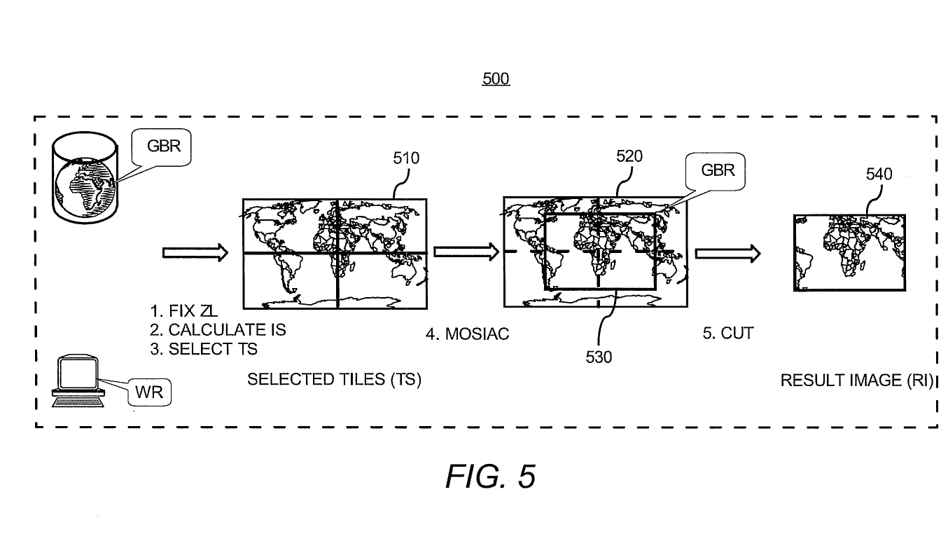

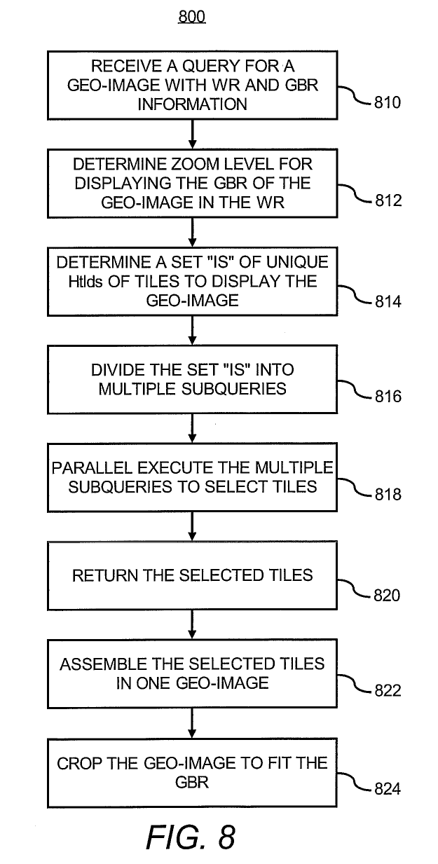

The second process in the H-Tiling scheme for retrieving the tiles that intersect with a query window is described below with reference to FIG. 8, with further illustration from a data flow chart 400 illustrated in FIG. 4 and an image request process 500 illustrated in FIG. 5.

At 810, a query for a geo-image of a geographical region in geographical area of coverage, such as the square R discussed above, is received at an application server 450 (FIG. 4). The query may be directly provided at the application server 450 or through a data network, such as the Internet or an intranet (not illustrated). For example, a web-mapping user may initiate a query by initiating a drag or zoom operation on a map to view a geo-image of a particular location in a client web browser, which executes a web-mapping application as provided by the application server 450. In turn, the client web browser sends the query via the Internet to the application server 450 as instructed by the web-mapping application. The query is a request that includes information or a description of a viewing window rectangle (WR) represented by its width and height (e.g., 500×600) and a corresponding GBR to be viewed in the WR. The GBR is represented by its minimum and maximum longitudes and its minimum and maximum latitudes, e.g., 100.03°/102.05° for minimum/maximum longitude and 30.4°/31.2° for minimum/maximum latitude. This query, as represented by the data flow 412 in FIG. 4, is sent to the application server 450.

At 812, the application server 450 determines or calculates the required resolution for displaying the requested geo-image based on the received WR and GBR information. From the calculated resolution, a closest zoom level (ZL) is also selected because each ZL has a definite resolution according to the quad-tree structure used to subdivide the image tiles. ZL is the level to retrieve a set of image tiles that overlaps with or occupies the requested GBR. This calculation is represented by the data flow 412 (FIG. 4).

At 814, the application server 450 also determines or calculates a set of unique H-Tiling IDs, i.e., Htlds, of the image tiles based on the GBR and ZL information. As noted earlier, given the ZL information and points on the GBR, the Htlds may be calculated. The set of calculated Htlds, or ID set (IS), represents the query as originally received by the application server 450 at 810.

At 816, the application server 450 rewrites or divides the query, i.e., the set IS, as multiple subqueries to be executed in parallel in the processing nodes of a parallel database, such as the parallel DBMS 470 (FIG. 4). Because the query has been converted to the set IS, i.e., a set of Htlds, it may be subdivided into multiple subqueries, each including one or more Htlds, in the same manner that the index of the unique Htlds was partitioned at 722 above.

At 818, the set IS, as subdivided, is provided to multiple processing nodes in the DBMS server 470 for parallel execution in these nodes to access or retrieve the corresponding image tiles therein based on the non-spatial indexing of the Htlds. This is illustrated by the data flow 416 (FIG. 4). Both the application server 450 and the DBMS server 470 may be included in a H-Tiling system that is hosted by a service provider, such as a web-mapping service provider.

At 820, from the parallel processing, the DBMS server 470 returns a set or mosaic of the selected tiles (TS) that corresponds to the set IS to the application server 450. This is illustrated by the data flow 418 (FIG. 4) and the TS 510 (FIG. 5).

At 822, the application server 450 assembles the mosaic of selected tiles into one geo-image 520 (FIG. 5), based on the image content in the selected tiles.

At 824, based on the received GBR information, the application server 450 crops the assembled geo-image to cut out those portions of the geo-image that is outside of the GBR 530 in order to form a resulting image (RI) 540 (FIG. 5). This is illustrated by the data flow 414 (FIG. 4).

In one embodiment, the aforementioned H-Tiling system may be provided with a standard Web Coverage Service (WCS) interface. This makes it easy to form a service chain with other geographic information services. For example, tiling-based image access may be integrated with the retrieval of other geographic location oriented information. These point location oriented information, such as cities, airports, are specified with geo-location (longitude and latitude), as well as with the identifier of the image tiles in which they are located. Although the image tile identifications may be derived from the location of the above points, these image tile identifications may be materialized and stored in a database for fast access. This tiling approach allows these point location oriented information as well as the relationships of these points to be accessed in a two-phase filtering process. For example, when a mapping query is about “an airport nearby a city,” the area covered by the image tiles that cover around the geo-location of the city is identified, and the geo-locations of the airports within that area are first selected in a first-phase filtering. Next, the search results may be refined in a secondary filtering to select the nearest one of the selected airports.

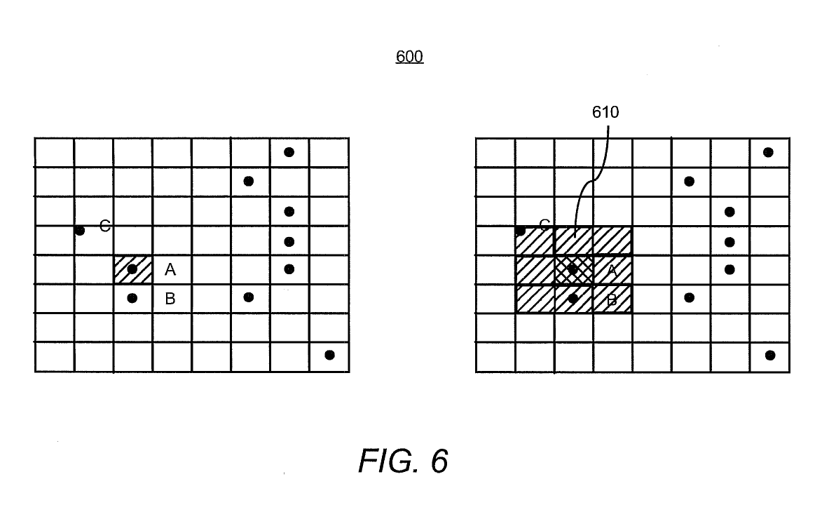

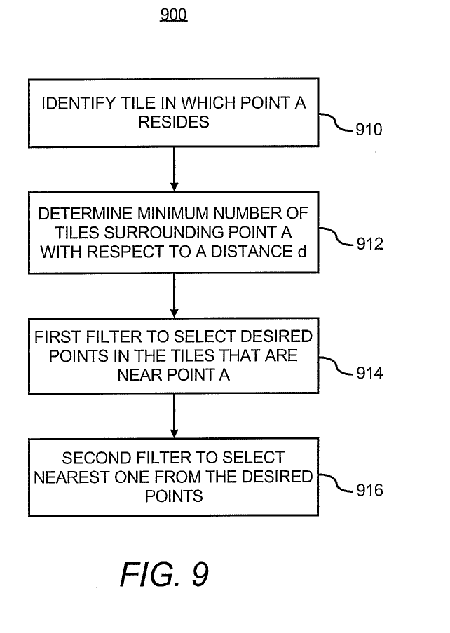

FIG. 9 illustrates a method 900, which is the aforementioned tiling approach, with reference to an illustration in FIG. 6, where the points with distance (A, P)<d are desired to be found, where point A is the city, point P is the airport, and d is some desired maximum distance between A and P (for a “nearby” airport).

At 910, the tile of desired point A (i.e., a desired location) is identified based on its geo-location and the image content of the multiple tiles stored, for example, in the DBMS server 470. This is performed in similar manner to as described in FIG. 8 at 812 and 814.

At 912, the minimal number of surrounding tiles (shown as the blocks 610 in FIG. 6) with respect to d is calculated or determined.

At 914, from a first approximate filtering based on the image contents in the surrounding tiles and the point location oriented information, airport points B and C are selected as candidates in the calculated tiles.

At 916, refinement is made with a second filtering, wherein the airport point B is satisfied as being near the city point A with distance smaller than d.

This image-tile based two phase filtering process is illustrated in FIG. 7, which significantly enhanced the nearest neighbor search using pair-wise comparison. Note that the hierarchical tilling scheme can be used to step-wise narrow down the search area.

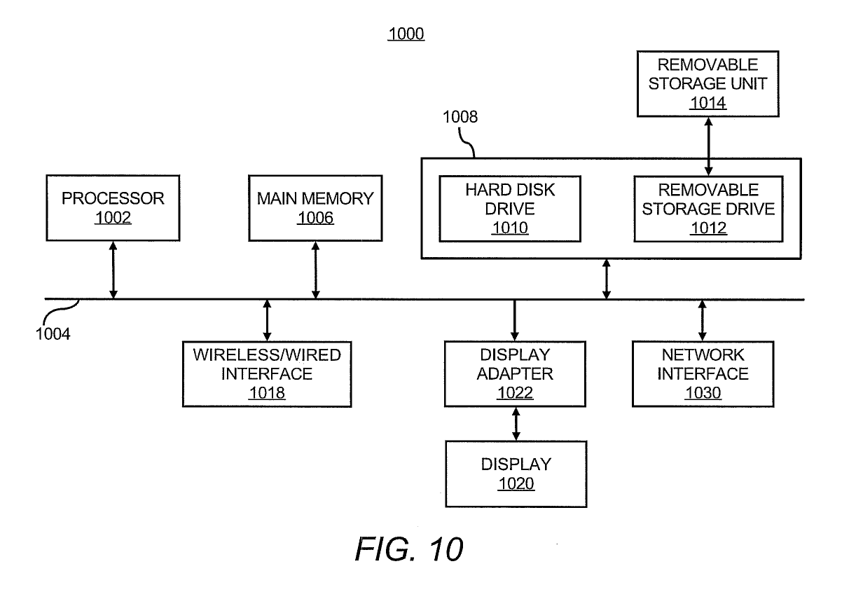

FIG. 10 illustrates a block diagram of a computerized system 1000 that is operable to be used as a computing platform for implementing the application server 450 and the DBMS server 470 described earlier. The computerized system 1000 includes one or more processors, such as processor 1002, providing an execution platform for executing software. In the case of the DBMS server 470, multiple processors are included therein to provide multiple processing nodes. Thus, the computerized system 1000 includes one or more single-core or multi-core processors of any of a number of computer processors, such as processors from Intel, AMD, and Cyrix. As referred herein, a computer processor may be a general-purpose processor, such as a central processing unit (CPU) or any other multi-purpose processor or microprocessor. A computer processor also may be a special-purpose processor, such as a graphics processing unit (GPU), an audio processor, a digital signal processor, or another processor dedicated for one or more processing purposes. Commands and data from the processor(s) 1002 are communicated over a communication bus 1004 or through point-to-point links with other components in the computer system 1000.

The computer system 1000 also includes a main memory 1006 where software is resident during runtime, and a secondary memory 1008. The secondary memory 1008 may also be a computer-readable medium (CRM) that may be used to store a database of the image tiles for retrieval and software applications for web mapping and database querying. The main memory 1006 and secondary memory 1008 (and an optional removable storage unit 1014) each includes, for example, a hard disk drive 1010 and/or a removable storage drive 1012 representing a floppy diskette drive, a magnetic tape drive, a compact disk drive, etc., or a nonvolatile memory where a copy of the software is stored. In one example, the secondary memory 1008 also includes ROM (read only memory), EPROM (erasable, programmable ROM), EEPROM (electrically erasable, programmable ROM), or any other electronic, optical, magnetic, or other storage or transmission device capable of providing a processor or processing unit with computer-readable instructions.

The computer system 1000 includes a display 1020 connected via a display adapter 1022, user interfaces comprising one or more input devices 1018, such as a keyboard, a mouse, a stylus, and the like. The display 1020 provides a display component for displaying the GUI 100 (FIG. 1) and GUI 200 (FIG. 2), for example. However, the input devices 1018 and the display 1020 are optional. A network interface 1030 is provided for communicating with other computer systems via, for example, a network such as the Internet to provide users with access to database of image tiles.

What has been described and illustrated herein is an embodiment along with some of its variations. The terms, descriptions and figures used herein are set forth by way of illustration only and are not meant as limitations. Those skilled in the art will recognize that many variations are possible within the spirit and scope of the subject matter, which is intended to be defined by the following claims—and their equivalents—in which all terms are meant in their broadest reasonable sense unless otherwise indicated.

What is claimed is:

1. A method for provisioning a geographical image for retrieval, comprising:
identifying a geographical area of coverage;
subdividing the desired geographical area of coverage into a plurality of tiles that are arranged hierarchically in multiple levels, the tiles are provided with a corresponding geographical image of the geographical area of coverage to form image tiles;
assigning a unique identification (ID) to each of the plurality of image tiles;
organizing the plurality of image tiles and the unique IDs in a table that corresponds one of the unique IDs with one of the plurality of image tiles;
indexing the unique IDs in the table with a non-spatial index to form an index of the unique IDs for querying;
partitioning the table using a first database management system (DBMS) partitioning scheme to divide the plurality of image tiles for storage in a plurality of processing nodes of a DBMS; and
partitioning the index of the unique IDs using a second DBMS partitioning scheme to divide the unique IDs for storage in the plurality of processing nodes of the DBMS.

2. The method of claim 1, wherein partitioning the index of the unique IDs comprises:
co-partitioning the index of the unique IDs with the partitioning of the table so that each partition of the unique IDs and the image tiles that the each partition indexes are located in the same processing node in the DBMS.

3. The method of claim 1, wherein partitioning the table using the first DBMS partitioning scheme comprises:
partitioning the table using at least one of a hash partitioning scheme and a range partitioning scheme.

4. The method of claim 1, wherein partitioning the index of the unique IDs using the second DBMS partitioning scheme comprises:
partitioning the index of the unique IDs using at least one of a hash partitioning scheme and a range partitioning scheme.

5. The method of claim 1, wherein the first and second DBMS partitioning schemes are the same.

6. The method of claim 1, wherein the first DBMS partitioning scheme includes a hash partitioning scheme, and partitioning the table using the first DBMS partitioning scheme comprises:
selecting a partition-level;
partitioning the table using the hash partitioning scheme above the selected partition level.

7. The method of claim 6, wherein the first DBMS partitioning scheme further includes a range partitioning scheme, and partitioning the table using the first DBMS partitioning scheme comprises:
partitioning the table using the range partitioning scheme below the selected partition level.

8. The method of claim 1, further comprising:
receiving a query for a requested geographical region in the geographical area of interest;
subdividing the query into multiple subqueries in accordance with the second DBMS partitioning scheme used to partition the index of the unique IDs of the plurality of image tiles;
providing the multiple subqueries to the plurality of processing nodes of the DBMS for parallel processing of the subqueries;
parallel processing the multiple subqueries with the processing nodes of the DBMS to retrieve one or more of the plurality of image tiles that overlap the requested geographical region;
assembling the retrieved one or more image tiles into a geographical image of the requested geographical region; and
responding to the query with the geographical image.

9. The method of claim 8, wherein receiving the query for the requested geographical region comprises:
receiving a description of a viewing window for viewing the requested geographical region; and
receiving a description of a geographical boundary window of the requested geographical region that is to be viewed in the viewing window.

10. The method of claim 9, further comprising:
cropping the geographical image to fit the geographical boundary window.

11. The method of claim 8, further comprising:
determining the one or more image files that overlap the requested geographical region; and
identifying a set of one or more of the unique IDs that are assigned to the one or more image files.

12. The method of claim 11, wherein subdividing the query into multiple subqueries comprises:
subdividing the set of one or more unique IDs into a plurality of subsets of one or more unique IDs.

13. The method of claim 1, further comprising:
identifying a first desired location in the geographical area of coverage;
identifying a first one of the plurality of image tiles having the first desired location therein;
determining one or more of the plurality of image tiles that surround the first tile based on a desired distance from the first desired location; and
filtering the first image tile and the one or more surrounding tiles to identify one or more secondary desired locations therein.

14. The method of claim 13, further comprising:
filtering the identified one or more secondary desired locations to determine at least one of the one or more secondary desired locations that identifying a second desired location in the geographical area of coverage.

15. The method of claim 1, wherein subdividing the desired geographical area of coverage into a plurality of tiles comprises subdividing the desired geographical area of coverage into a plurality of tiles of equal size.

16. A system for provisioning a geographical image for retrieval, comprising:
an application server operating to receive a query for a geographical region in a geographical area of coverage; and
a database server operating to store a plurality of geo-image tiles that cover the geographical area of coverage at different zoom levels, the database server is coupled to the application server to receive the query from the application server and return one or more of the plurality of geo-image tiles to illustrate the geographical region requested in the query;
wherein the plurality of geo-image tiles are partitioned for storage in the database server in accordance with a database management system (DBMS) scheme and indexed or retrieval with a non-spatial index.

17. The system of claim 16, wherein the application server further operating to divide the query into multiple subqueries for paralleling processing of the query.

18. The system of claim 17, wherein the database server includes:
a plurality of processing units to process the query by parallel processing the subqueries received from the application server.

19. The system of claim 16, wherein the plurality of geo-image tiles at each of the different zoom levels are of equal size.

20. A computer readable medium on which is encoded computer programming code executed by a computer processor to:
identify a geographical area of coverage;
subdivide the desired geographical area of coverage into a plurality of tiles that are arranged hierarchically in multiple levels, the tiles are provided with a corresponding geographical image of the geographical area of coverage to form image tiles;
assign a unique identification (ID) to each of the plurality of image tiles;
organize the plurality of image tiles and the unique IDs in a table that corresponds one of the unique IDs with one of the plurality of image tiles;
indexing the unique IDs in the table with a non-spatial index to form an index of the unique IDs for querying;
partition the table using a first database management system (DBMS) partitioning scheme to divide the plurality of image tiles for storage in a plurality of processing nodes of a DBMS; and
partition the index of the unique IDs using a second DBMS partitioning scheme to divide the unique Ds for storage in the plurality of processing nodes of the DBMS.
